(19) United States
(12) Patent Application Publication
(10) Pub. No.: US 2008/0190681 A1
(43) Pub. Date: Aug. 14, 2008

(54) Operator Control Device For A Driver Assistance System For A Motor Vehicle

(75) Inventors: Christoph MAYSER, Unterhaching (DE); Karl Naab, Woerth (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 12/024,682

(22) Filed: Feb. 1, 2008

Related U.S. Application Data
(63) Continuation of application No. PCT/EP2006/007531, filed on Jul. 29, 2006.

(30) Foreign Application Priority Data
Aug. 5, 2005 (DE) 10 2005 036 923.5

(51) Int. Cl. B60K 31/00

(52) U.S. Cl. 180/170

(57) ABSTRACT

An operator control device, which is intended for a driver assistance system of a motor vehicle and which exhibits a controller for controlling the acceleration of the motor vehicle as a function of a setpoint acceleration/setpoint deceleration, includes acceleration operator control element for inputting an additional acceleration, which can be predefined by the driver of the motor vehicle and acts on the controller.

### CROSS-REFERENCE TO RELATED APPLICATIONS

This application is a continuation of PCT International Application No. PCT/EP2006/007531, filed on Jul. 29, 2006, which claims priority under 35 U.S.C. §119 to German Application No. 10 2005 036 923.5, filed Aug. 5, 2005, the entire disclosures of which are expressly incorporated by reference herein.

### BACKGROUND AND SUMMARY OF THE INVENTION

The invention relates to an operator control device, which is intended for a driver assistance system for a motor vehicle and which exhibits a controller for controlling the acceleration of the motor vehicle as a function of a setpoint acceleration/deceleration.

In general, driver assistance systems for longitudinal guidance of a vehicle can be implemented for a number of different spheres of action. Thus, for example, informational and/or warning distance-information systems indicate in an acoustical, optical or haptical manner to the driver that the distance of the motor vehicle from a preceding vehicle is too short. Then, the driver can decide whether and how he can correct, as a function of the situation, his driving speed and the momentary distance. Assistance systems, which make semi-automatic recommendations, use, for example, a so-called active gas pedal, which immediately informs the driver about the momentary “correct” gas pedal position by means of artificial additional forces in the gas pedal. The gas pedal position is necessary for maintaining the adapted speed or the correct distance from a preceding vehicle. The driver himself decides how he wants to translate the information regarding the correcting value that is proposed directly by the system. Automatic distance control systems, such as an ACC system, endeavor to assume the entire longitudinal guidance for specific driving situations.

The driving speed control system or the ACC system usually enables the driver to set the desired speed at the steering wheel using an operator control element, for example a pitman arm or push buttons. Then, the system controls the speed, if desired, as a function of the temporal distance from a vehicle traveling ahead.

Then, the driver can change the desired speed with the pitman arm and/or the push buttons, or can deactivate the system with these operator control elements. Furthermore, it is usually possible for the driver to override (equals higher speed) the system by using the gas pedal. As a result, the control system ceases temporarily to have an effect; and the system is deactivated with the brake pedal. According to this prior art system philosophy, the driver can either rely on the system and let the system drive, in which case certain specifications can be made, as described above; or the driver can turn off the system and do the driving himself. If the driver lets the system drive, he becomes an observer/monitor of the system and can indirectly influence the system, but he is not actively involved in the control process (maintaining speed and distance). When the system reaches one of its limits, the step demands that the driver assumes the active control again—a role change. Many drivers find this role change to be inconvenient and, hence, it is delayed as long as possible.

According to the current and foreseeable future of the state of the art that can be expected, it is not possible to transfer the entire longitudinal guidance of the vehicle to the driver assistance system. There are still a number of driving situations, with which the automatic distance control system cannot cope or can cope only to an inadequate extent in practical traveling situations. Important factors are, on the one hand, the limited detection capacity of the conventional modern driving environment sensing systems. However, on the other hand, the decisive factor is of a generic nature. From the perspective of the overall task of driving, the ACC fully automates to some degree individual tasks within the total longitudinal guidance task, which interferes to a considerable extent with the remaining operating and control activities of the driver. The driver must interact with the automatic system. In the case of ACC, this system is programmed in essence only with respect to maintaining the distance or—during unobstructed travel—with respect to maintaining a desired speed. However, driving a car is a dynamic process, during which it is usually not possible to maintain absolutely constant time gaps or fixed desired speeds, but rather deviations from these simple rules of the ACC system occur at a significant frequency. As a result, a plethora of conflicts with the driver's expectations or a typical behavior of the driver are preprogrammed.

Some examples are vehicles cutting in front of the vehicle, vehicles turning off, sensor coverage ranges that are too short, late reaction to a fast approaching vehicle, imprecise/uncertain lane allocation, lane change, limited deceleration capacity, no reaction to objects that are standing still, misinterpretation of apparently relevant objects, non-detection of relevant objects, etc.

In these cases, as stated above, the driver has the choice in the modern functional and operating designs of the ACC of either turning off the system or taking over the control himself by depressing the OFF button. Or, if some other deceleration than that initiated by the system is necessary, the driver can turn it off at the same time that he operates the brake pedal. In order to generate an acceleration that is higher than that specified by the system, the driver has to operate the gas pedal. In this case, the system function recedes briefly into the background and is re-activated when the gas pedal is released. In both cases, an interruption in the natural dynamic flow of travel is produced with the disengagement. Re-engagement, which often follows a short time after the disengagement, usually brings about a clearly perceptible transient effect. Furthermore, in both cases the intervention also involves an excessive manual operating effort.

In order to achieve better acceptance and a more harmonic interaction between the driver and the semi-automated system, it is, therefore, advised to provide measures that enable better involvement of the driver in order to improve the method for informing the system, on the one hand, of the driver's diverging assessment of the driving situation and, on the other hand, in particular, his intentions, so that the entire driving process is more homogeneous.

To this end, German patent document DE 103 03 611 A1 describes a speed controller with a plurality of operating modes, where a “stop and go mode” is provided as one operating mode; and an ACC mode is provided as a second operating mode. In these two modes, it is possible for the driver to operate the gas pedal and, thus, override the stop and go control function and/or the ACC control function. Therefore, during override, these functions are deactivated and are resumed following the override.

Furthermore, German patent document DE 10 2004 040 532 A1 discloses a vehicle object detection system, a preceding vehicle following control system, and a vehicle control system, which exhibits an acceleration/deceleration request detector for sensing an occupant's request for an acceleration or deceleration on the basis of the actuation of the brake pedal by the occupant, the actuation of a gas pedal by the occupant, an actuation of a switch by the occupant, and/or a voice of the occupant. On the basis of the sensed acceleration/deceleration request, a coverage range of the sensor that is used for the ACC system is changed. In particular, upon a request for a deceleration, the coverage range is increased laterally, if the occupant's request for a deceleration is sensed so that vehicles, cutting in from the side in front of the vehicle to be controlled, are detected earlier, and the system automatically adjusts itself to those vehicles. In contrast, the coverage range is decreased laterally, if the acceleration/deceleration detector senses a request for an acceleration, thus preventing an unnecessary execution of a vehicle control on the basis of the vehicles cutting in from the side.

German patent document DE 103 43 178 A1 discloses a driver assistance system with variable longitudinal guidance strategies. This system exhibits a strategy module for the variable determination of the longitudinal guidance system to be applied. In this case, there are a variety of different longitudinal guidance strategies, such as “comfort emphasized,” “normal” or “dynamic,” which are or can be stored beforehand. The driver can select one of these strategies before starting the trip and, if necessary, also during the trip. Basically the strategies differ in their different positive/negative acceleration characteristics. Operator control elements for selecting and/or storing the various longitudinal guidance strategies are not described.

German patent document DE 196 40 694 A1 describes a method and a device for controlling the driving speed of a vehicle. In this case, the limit of the speed change of the vehicle, as a function of the driver's desired dynamic characteristic of the vehicle, in particular as a function of the shift state of at least one driver-operable operator control element, is suspended or set to higher values. In this case, the acceleration and/or the deceleration dynamics of a driving speed control system are designed so as to be adjustable. Therefore, since the driver sets the acceleration and/or deceleration dynamics, he is tied into the system. Since in this case the limit values of the maximum acceleration and/or deceleration that is set by the system are changed, the effect of the intervention becomes clear only when the automatic speed control system executes an acceleration, acceleration change, deceleration and/or a deceleration change that exceeds the old limit values.

Moreover, German patent document DE 100 19 190 A1 discloses a method for the adaptive control of the separation distance and/or driving speed of a motor vehicle. In this case, the magnitude representing the setpoint acceleration is formed and/or limited at least as a function of at least one base value; and external and internal acceleration requests can be converted by way of respectively defined of base values. In particular, for comfort and safety reasons, the vehicle acceleration ought not to be changed in arbitrary jumps, but rather the jolt, which is defined as a temporal change in acceleration, is limited by limit values in the positive and negative direction. Then a new setpoint acceleration is determined by way of a minimum base value, a maximum base value, the limit values, and the past setpoint acceleration. The maximum base value is that value that must exceed at least a setpoint acceleration defined by the ACC controller, so that a positive acceleration change of the vehicle ensues. The minimum base value is that value that must fall below at least a setpoint acceleration that is defined by the ACC controller, so that a negative acceleration change of the vehicle ensues. During active control, the minimum base value and the maximum base value are formed from a current base value and the last setpoint value. During all transitions into the drive case or the active control mode, the minimum base value and the maximum base value are initialized to the current base value. During control with brake intervention, the minimum base value and the maximum base value are formed from base values, provided by a deceleration controller and/or an active brake, and the last setpoint value. When the setpoint value is below the minimum acceleration of the drive, but the brake intervention has not yet been activated, the maximum base value is formed by way of a minimum acceleration value; and the minimum base value is formed by way of a minimum acceleration value, decreased by a brake engagement hysteresis value. If the driver of the motor vehicle requests a higher engine output than the ACC system demands (driver override), the maximum base value is set as the current base value; and the minimum base value is set as a value a_{DrvMin} that is not closely defined. In this case, too, no specific operator control elements for inputting the driver's request are described.

The common feature of all of these systems is that the driver is always confronted with the decision of whether he would like to let the system drive or whether he himself would like to drive. Only in an indirect manner is it possible to intervene in the system, which the intervention does not disengage-at least temporarily. For this reason, critical situations cannot be adequately avoided by decelerating or accelerating while simultaneously maintaining the active control.

Furthermore, German patent document DE 103 43 177 A1 discloses a man/machine interface for a driver assistance system of a motor vehicle. The interface includes an input device for inputting at least one command for the activation of a function of the driver assistance system; a memory, in which a plurality of activation conditions for the function are stored; and a control unit, which examines the activation conditions when a command is inputted. An output device, which is controlled by the control unit and which, when an activation condition is not fulfilled, outputs a text message identifying the activation condition. In this way, the driver can be informed of a reason as to why a certain function cannot be activated. One example of an input device is a multi-functional lever, which is mounted on the steering wheel of the vehicle and which enables the driver to activate by choice the ACC function or the LSF function, to set the current speed of the vehicle as a desired speed, to increase or to decrease the desired speed, and to suspend temporarily or resume the ACC and/or LSF function.

Accordingly, the invention provides an improved operator control device for a driver assistance system for a motor vehicle. The device exhibits a controller for controlling the acceleration of the motor vehicle as a function of a setpoint acceleration.

According to the invention, an operator control device is provided, which is intended for a driver assistance system for a motor vehicle and which exhibits a controller for controlling the acceleration of the motor vehicle as a function of a setpoint acceleration (this also includes a setpoint deceleration, i.e., a negative setpoint acceleration), and which exhibits an acceleration operator control element for inputting an additional acceleration, which can be predefined by the driver of the motor vehicle and acts on the controller.

Consequently, the invention offers a careful embedding of the possible interventions in the driver assistance system into the natural and intuitive actions and reactions of the driver. The use of an acceleration operator control element to tie in an additional acceleration, which can be predefined by the driver of the motor vehicle, enables the driver, by means of a higher-ranking control system, to feed additional acceleration requests into the speed control system. Owing to the control concept, the driver's requests and the system's requests are processed and adjusted to form a total acceleration request. Owing to this procedure, the operating mode changes such that now the driver and the system are driving together. Therefore, there is no need for the driver to disengage the system so often. The driver can override the system in certain situations (through an additional acceleration demand) without having to disengage the system. Once the driving situation has been resolved, the driver retires (terminates his additional request); and the system automatically takes over again the complete control. Thus, the driver is actively involved in the control process and is, therefore, “in the loop.”

Consequently, the scale of automation—for example, the ACC function—is reduced, according to the invention, such that the driver can modify the setpoint acceleration, provided by the ACC controller, or the setpoint deceleration (=negative setpoint acceleration) of the vehicle by use of the acceleration operator control element such that his driving request (acceleration or driving speed request), which deviates from the ACC system and which may or may not be justified by his assessment of the driving situation that deviates from the ACC system, can inform the acceleration controller in the ACC system without having to interrupt the ACC function.

Such an acceleration operator control element for superimposing the driver's request with a setpoint acceleration or setpoint deceleration that diverges from the system's request can exhibit a defined zero position and a positive and negative setting range that can be scanned continuously.

Furthermore, over the course of the setting range, it can exhibit an additional force jump in order to point out, for example, a definite jump in the acceleration request (similar to the kick down in the gas pedal). This operator control element is arranged preferably within the reachable grasping range of the driver—for example, in the vicinity of the automatic transmission selector lever, in a multi-function steering wheel, in the form of a pitman arm, etc. The operator control element is chosen preferably in conformity with the driver's expectations, so that the driver's intuitive reactions with respect to acceleration and deceleration are facilitated, if possible, without any reactive operating error. For example, if the operator control element is arranged horizontally, the following operating arrangement may be desirable: forward direction=increase the system acceleration, rearward direction=decrease system acceleration.

Owing to these values, generated by the operator control element by way of the driver, the system-generated setpoint acceleration is modified in such a manner that the effect of the system is continuously weakened, and the effect of the driver's manipulation is strengthened. The characteristics of the insertions by use of the operator control element may be designed in any linear, progressive, digressive, symmetrical, or non-symmetrical manner, and/or with its own time response, in order to satisfy the requirements with respect to modulation, vehicle reaction, driving dynamics experience, optimal driver-vehicle control loop performance, etc.

The acceleration operator control element according to the invention includes, preferably, an increment encoder with two directions. In this case the increment encoder with two directions can be an analog or a digital element, which has the function of sensing or emitting an operating direction—for example, “upwards/downwards” or “to the right/to the left”—and an operating intensity—for example, “a distance of x % from the zero position” or “up to the stop limit” or “x revolutions” or “x increments”—or a force or a pressure of an actuation or an operating speed or a time duration of an actuation. It can also be, for example, a position transducer—for example, in the form of a potentiometer—or also a pulse generator, a sensor, or a combination of these.

The acceleration device according to the invention indicates preferably a set acceleration and/or an elapsed time of a set acceleration. Such a display can be provided directly on the acceleration operator control element, for example, by way of a marking or separately thereof, for example, by way of an analog or digital display unit.

The acceleration operator control element of the invention is disposed preferably on the steering wheel of the motor vehicle, in particular preferably on a left spoke thereof. However, the acceleration operator control element of the invention may also be disposed, if desired, on a right spoke of the steering wheel of the motor vehicle or on both sides of the steering wheel. It is not even absolutely necessary to mount the acceleration operator control element of the invention on a spoke of the steering wheel.

In the case that the acceleration operator control element is mounted on the steering wheel of the motor vehicle and preferably on its right spoke, the inventive operator control device has an additional operator control element, preferably a speed operator control element which includes an increment encoder with two directions. The increment encoder may have, in principle, the same functionality as the increment encoder of the acceleration operator control element, in order to set or change the desired speed. In this case, the speed operator control element includes preferably a knurled wheel or a roll. Such a design is also chosen preferably for the acceleration operator control element, which is provided as an increment encoder with two directions. Preferably, an analog or continuous increment encoder is used as the acceleration operator control element; and a digital or discrete increment encoder is used as the speed operator control element.

As an alternative or in addition, the operator control device according to the invention includes, as an additional operator control element, preferably a distance operator control element, which includes an increment encoder with two directions, in order to set the desired distance. In this case, the distance operator control element also preferably has a rocker switch. Even this increment encoder may be designed in an analog (continuous) or digital (discrete) manner. Then, the desired distance may be set and/or changed, for example, by means of the intensity or duration of the actuation or a number of actuations.

As another alternative or in addition, the operator control device according to the invention includes, as an additional operator control element, preferably a deactivation operator control element, which has an increment encoder with one step, in order to deactivate the driver assistance system. In this case, the deactivation operator control element also includes preferably a push button. The deactivation operator control element may be designed in such a manner that an activation for engagement must ensue for a certain period of time in order to be accepted, whereas an activation for disengagement is accepted immediately.

As another alternative or in addition, the operator control device according to the invention includes, as an additional operator control element, preferably a speed-set push button, which has an increment encoder with one step, in order to set an actual speed as the setpoint speed.

As another alternative or in addition, when the controller for controlling the acceleration of the motor vehicle is inactivated, the acceleration operator control element fulfills the function of a shift lever for selecting a gear of a transmission of the motor vehicle.

Thus, the acceleration operator control element according to the invention is arranged preferably in a manner that it is easy for the driver to reach, moreover, preferably on the steering wheel. One practical design provides that the acceleration operator control element is mounted on the left spoke of the steering wheel. Furthermore, it is also practical to mount the remaining operator control elements of the operator control device for the speed/distance control system on the left spoke of the steering wheel.

The invention provides preferably:
An analog increment encoder/setpoint generator with two directions in order to set acceleration requests. In this case, the set value (preferably as an angle) and the elapsed time can be read, in order to set this value.
A discrete increment encoder with two directions in order to set the desired speed (many steps), preferably a knurled wheel or a roll.
A discrete increment encoder with two directions in order to set or change (few steps) the desired distance, preferably a rocker switch.
An increment encoder with one step in order to deactivate the system, preferably a push button.
An increment encoder with one step in order to activate the system and/or to resume the previously set speed and/or acceleration values, preferably a push button or a roll, which is used in a variety of ways (also for other functions).
An increment encoder with one step in order to take over an actual speed as the setpoint speed, preferably a push button.

Therefore, the invention makes it possible to significantly improve the function and/or to significantly enhance the understanding of the function at a very low additional cost. At the same time, the service life and the weight of the vehicle are not affected.

Other objects, advantages and novel features of the present invention will become apparent from the following detailed description of the invention when considered in conjunction with the accompanying drawings.

### BRIEF DESCRIPTION OF THE DRAWINGS

FIG. 1 depicts a steering wheel with an operator control device for a driver assistance system of a motor vehicle in accordance with an advantageous embodiment of the invention; and

FIG. 2 is an enlarged detail view of the operator control device according to the invention, which is depicted in FIG. 1 and which shows a preferred embodiment of the invention.

### DETAILED DESCRIPTION OF THE DRAWINGS

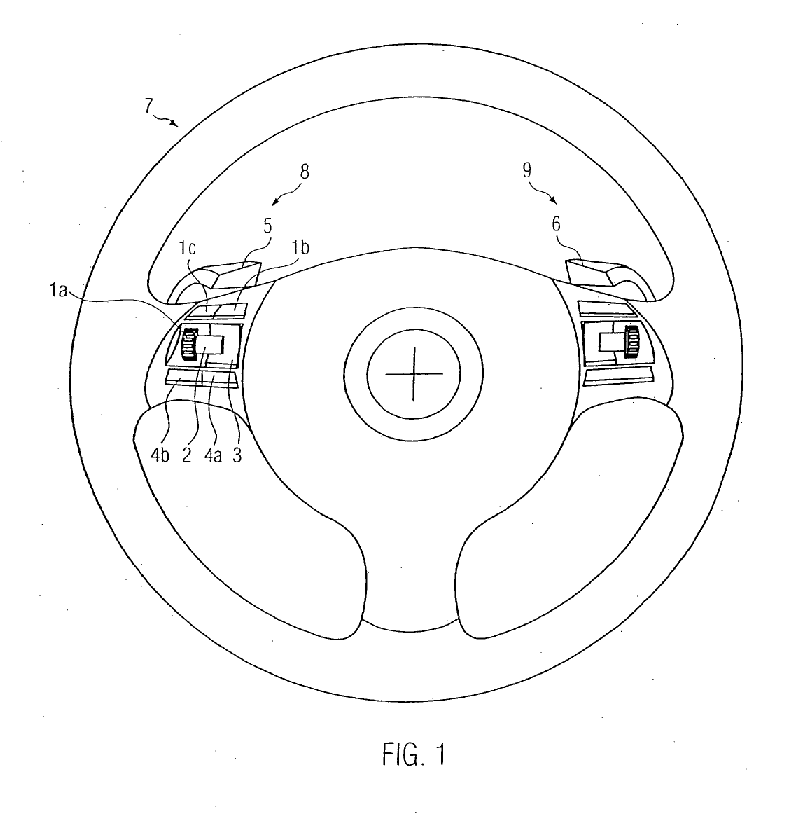

FIG. 1 depicts a steering wheel 7, equipped with an operator control device according to the invention. In this case, operator control devices according to the invention are present on both the left spoke 8 and the right spoke 9, in order to enable the driver to operate the driver assistance system with both the left and the right hand. The operator control devices, which are shown in this case, are symmetrical and exhibit the same features. It is a preferred, but not an absolutely mandatory design.

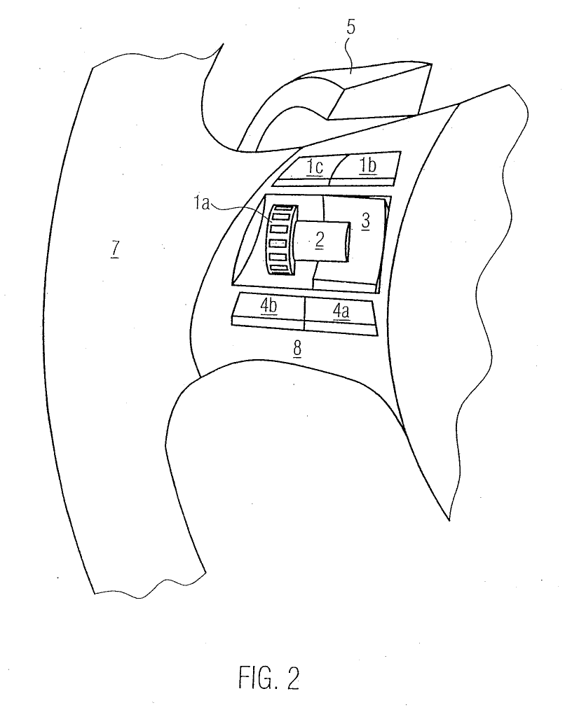

FIG. 2 is an exploded drawing of the left spoke 8 of the steering wheel 7 of FIG. 1, provided with the operator control device according a preferred embodiment of the invention.

A first design of the preferred embodiment (shown here) of the operator, control device according to the invention includes an acceleration operator control element 1a in the form of an analog or quasi-analog (that is, stepless or very finely graduated) increment encoder, which is constructed as a knurled wheel or roller and which lies immediately adjacent to the gripping region of the steering wheel 7. Arranged to the right of the acceleration operator control element 1a is a speed operator control element 2, which can be operated on the same axis, but independently of the acceleration operator control element 1a. The speed operator control element 2 also has an increment encoder, which is constructed as a knurled wheel or roller. To the right thereof and partially below the speed operator control element 2, a distance operator control element 3 is arranged in the form of an increment encoder having two directions and being constructed as a rocker switch.

Arranged below this unit, consisting of the acceleration operator control element 1a, the speed operator control element 2 and the distance operator control element 3, the left spoke 8 also exhibits a deactivation operator control element 4a, 4b in the form of a one step increment encoder-that is, a push button. The push button may consist of two single push buttons 4a, 4b, which have the same function, but of which one may be used for activating and one for deactivating. Above the aforementioned unit there are two display units—that is, a display unit 1b that displays an elapsed time of a set acceleration, and a display unit 1c, which displays a set acceleration. As an alternative, the set acceleration may also be provided by way of a marking on the increment encoder, which belongs to the acceleration operator control element 1a and which is designed as a knurled wheel or roller. A shift lever 5, with which a transmission gear may be selected, is mounted above the display units 1b, 1c above and behind the left spoke 8. The shift lever 5 may be pushed towards the front (away from the driver) or towards the rear (towards the driver) in order to select a transmission gear (shift up or down). As an alternative, there may be a left shift lever 5 (on the left spoke 8) for shifting in one direction (shift up or down); and there may be a right shift lever 6 (on the right spoke 9 of the steering wheel) for shifting in the other direction (shift down or up). The display units 1b, 1c may display in an alternative, alternating, or additional manner or—in the event of a suitable actuation—the set values of the speed operator control element 2, the distance operator control element 3, and/or the shift lever(s) 5 (6).

A second design of the preferred embodiment (shown here) of the operator control device according to the invention includes a speed operator control element 1a in the form of an analog or quasi-analog (that is, stepless or very finely graduated) increment encoder, which is constructed as a knurled wheel or roller and which lies immediately adjacent to the gripping region of the steering wheel 7. To the right of the speed operator control element 1a there is a speed resume push button 2 (resume push button). To the right thereof and partially below the speed resume push button 2 there is a distance operator control element 3 in the form of an increment encoder, which has two directions and which is constructed as a rocker switch.

Below this unit, consisting of the speed operator control element 1a, the speed resume push button 2, and the distance operator control element 3, the left spoke 8 also exhibits on the right a speed set push button 4a in order to take over an actual speed and on the left a deactivation operator control element 4b in the form of two, one-step, increment encoders—that is, push buttons. Above the aforementioned unit there are two display units—that is, a display unit 1b that displays an elapsed time of a set acceleration, and a display unit 1c, which displays a set acceleration. These two display units 1b, 1c may also be dispensed with, especially in the event that there is a display by means of a central display instrument.

An acceleration operator control element 5 is provided above the display units 1b, 1c above and behind the left spoke 8. The acceleration operator control element can be pushed towards the front (away from the driver) or towards the rear (towards the driver) in order to select the accelerations (more intensive acceleration or deceleration). The operation ensues preferably in such a manner that if the acceleration operator control element 5 is pushed away, the result is a higher acceleration. If the acceleration operator control element is pulled towards the driver, the result is a more intensive deceleration (negative acceleration). As an alternative, a left acceleration operator control element 5 (on the left spoke 8) may be provided for accelerating in one direction (positive or negative); and a right acceleration operator control element 6 (on the right spoke 9 of the steering wheel) may be provided for accelerating in the other direction (negative or positive). The acceleration operator control element(s) may also exhibit a dual function—for example, during activated distance control system and/or activated driving speed control as an acceleration operator control element and otherwise as a shift lever(s). As a result, a transmission gear may be selected, as described above with respect to the first design of the preferred embodiment (illustrated here) of the operator control device according to the invention.

The display units 1b, 1c may also display in an alternative, alternating or additional manner or—in the event of a suitable actuation—the set values of the speed operator control element 1a and/or the distance operator control element 3 and/or the shift lever(s) 5 (6). As an alternative, the set speed may also be provided by way of a marking on the increment encoder, which belongs to the speed operator control element 1a and which is designed as a knurled wheel or roller.

The above described acceleration operator control element may be expanded in order to achieve comfort and also to include the effect of DME and brake manipulations. Furthermore, it is also possible to expand the operator control element to include the gas pedal and the brake of the vehicle.

With the configuration of the acceleration operator control according to the invention, it is possible to cope, for example, with driving situations, like a vehicle cutting in very closely, without having to apply the brakes and, thus, without having to deactivate the assistance system.

Other functions that are possible by tying in, according to the invention, an additional acceleration that can be predefined by the driver of the motor vehicle are:
stopping with the acceleration operator control element without any adjustment for a vehicle traveling ahead and combination with standstill management;
starting with the acceleration operator control element without any adjustment for a vehicle traveling ahead by means of a significant actuation in the direction of acceleration;
corrected stopping with adjustment for a vehicle traveling ahead in conjunction with a stop and go function of the ACC system;
controlled separation during the stopping operation with adjustment for a vehicle traveling ahead in conjunction with a stop and go function of the ACC system; and
start command with adjustment for a vehicle traveling ahead in conjunction with the stop and go function of the ACC system by means of a significant actuation in the direction of acceleration.

An acceleration operator control according to the invention in the form described in the example is not tied exclusively to the presence of a distance control system, like the ACC. The following variants are possible:
A) The acceleration operator control according to the invention can also be integrated—as described above—in a totally consistent manner into a driving speed control system with preselectable desired speed (V_{desired}). The advantages of a short-term decrease or increase in the driving speed by way of an acceleration operator control element are just as clear to the driver as in the case of an ACC control.
B) The acceleration operator control according to the invention can be integrated in a totally consistent manner into a driving speed control system without a preselectable desired speed. In the event of a manual input of a positive acceleration by way of the acceleration operator control element, the vehicle accelerates as a function of the input. When the acceleration operator control element is released (thus, involving an automatic reset into a neutral position), the vehicle holds the momentary speed until the driving speed control system is active. In the event of a manual input of a negative acceleration by way of the acceleration operator control element, the vehicle decelerates as a function of the input. When the acceleration operator control element is released (thus, involving an automatic reset into a neutral position), the vehicle holds the momentary speed until the driving speed control system is active. If during a manual input of a negative acceleration by way of the acceleration operator control element, the vehicle comes to a standstill, a standstill management becomes active. Starting or high acceleration of the vehicle, for example, by actuating the acceleration operator control element in the direction “accelerate” can also be implemented in a consistent manner.

This variant is comparable to a conventional use of a driving speed control system, where an acceleration is initiated by holding down the “+” push button for a prolonged period of time, for example. A deceleration is initiated by holding down the “−” push button for a prolonged period of time. However, the decisive difference between the operator control device according to the invention and such a conventional operator control design lies in the modulation of the respective acceleration or deceleration, the possible operating range over the entire speed range including standstill and the described standstill and start function.
C) An acceleration operator control can also be applied without a driving speed control—for example, as a manual acceleration or brake actuation. In this case, the brake actuation can be designed up to an emergency brake. The advantages may lie in the significantly faster vehicle reaction owing to shorter actuation time—for example, owing to the smaller mass of a thumb for actuating an acceleration operator control element as compared to the relatively large mass of a leg with footwear for actuating the service brake. Especially in an emergency braking situation, such a difference can reduce the braking distance by a few valuable meters, in particular since the acceleration operator control element can be designed in such a manner that a “stop limit” can be achieved faster than is the case with the service brake that has to be held down “with full force.”

### TABLE OF REFERENCE NUMERALS

1a acceleration operator control element/ speed operator control element
1b display of an elapsed time of a set acceleration
1c display of a set acceleration
2a speed operator control element/ speed resume push button
3 distance operator control element
4a deactivation operator control element/ speed set push button
4b deactivation operator control element
5 shift lever/ acceleration operator control element
6 shift lever/ acceleration operator control element
7 steering wheel
8 left spoke of the steering wheel
9 right spoke of the steering wheel

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An operator control device for a driver assistance system of a motor vehicle, the driver assistance system including a controller for controlling acceleration of the motor vehicle as a function of a set point acceleration, the operator control device comprising:
an acceleration operator control element for inputting an additional acceleration predefinable by a driver of the motor vehicle, the additional acceleration acting on the controller for controlling the acceleration of the motor vehicle.

2. The operator control device according to claim 1, wherein the acceleration operator control element comprises an increment encoder having two directions.

3. The operator control device according to claim 1 wherein the acceleration operator control element displays a set acceleration.

4. The operator control device according to claim 1, wherein the acceleration operator control element displays an elapsed time of a set acceleration.

5. The operator control device according to claim 1, wherein the acceleration operator control element is mounted on a steering wheel of the motor vehicle.

6. The operator control device according to claim 5, wherein the acceleration operator control element is mounted on a left spoke of the steering wheel of the motor vehicle.

7. The operator control device according to claim 5, wherein at least one additional operator control element of the driver assistance system is mounted on a spoke of the steering wheel of the motor vehicle, on which the acceleration operator control element is mounted.

8. The operator control device according to claim 6, wherein at least one additional operator control element of the driver assistance system is mounted on a spoke of the steering wheel of the motor vehicle, on which the acceleration operator control element is mounted.

9. The operator control device according to claim 7, wherein the additional operator control element of the driver assistance system is a speed operator control element, which comprises an increment encoder with two directions, in order to set a desired speed.

10. The operator control device according to claim 9, wherein the speed operator control element is one of a knurled wheel and a roller.

11. The operator control device according to claim 7, wherein the additional operator control element of the driver assistance system is a distance operator control element, which comprises an increment encoder with two directions, in order to set a desired distance.

12. The operator control device according to claim 11, wherein the distance operator control element is a rocker switch.

13. The operator control device according to claim 7, wherein the additional operator control element of the driver assistance system is a deactivation operator control element, which comprises an increment encoder with one step, in order to deactivate the driver assistance system.

14. The operator control device according to claim 13, wherein the deactivation operator control element is a push button.

15. The operator control device according to claim 7, wherein the additional operator control element of the driver assistance system is a speed set push button, which comprises an increment encoder with one step, in order to set an actual speed as the setpoint speed.

16. The operator control device according to claim 1, wherein when the controller for controlling the acceleration of the motor vehicle is inactivated, the acceleration operator control element fulfills the function of a shift lever for selecting a gear of a transmission of the motor vehicle.

17. The operator control device according to claim 9, wherein a further additional operator control element of the driver assistance system is a distance operator control element, which comprises an increment encoder with two directions, in order to set a desired distance.

18. The operator control device according to claim 17, wherein a further additional operator control element of the driver assistance system is a deactivation operator control element, which comprises an increment encoder with one step, in order to deactivate the driver assistance system.

19. The operator control device according to claim 18, wherein a further additional operator control element of the driver assistance system is a speed set push button, which comprises an increment encoder with one step, in order to set an actual speed as the setpoint speed.

20. The operator control device according to claim 19, wherein when the controller for controlling the acceleration of the motor vehicle is inactivated, the acceleration operator control element fulfills the function of a shift lever for selecting a gear of a transmission of the motor vehicle.
